(19) United States
(12) Patent Application Publication
(10) Pub. No.: US 2006/0139686 A1
(43) Pub. Date: Jun. 29, 2006

(54) Information processing apparatus, image forming apparatus, recording medium having recorded operation control program, and image forming system

(75) Inventors: Masayoshi Suzuki, Osaka-shi (JP); Eiji Mifune, Osaka-shi (JP); Katsushi Horihata, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/317,056

(22) Filed: Dec. 22, 2005

(30) Foreign Application Priority Data
Dec. 24, 2004 (JP) 2004-373888

(51) Int. Cl. G06F 3/12

(52) U.S. Cl. 358/1.15

(57) ABSTRACT

A printer group storage portion that stores a group made up of two or more printers, a print command acceptance portion that accepts an image formation job to form an image on a recording sheet, a data dividing portion that divides the image formation job accepted at the print command acceptance portion in units of pages for the respective printers in the group stored in the group storage portion, and a job transmission portion that distributes respective segments of the image formation job divided by the data dividing portion to the respective printers for the image forming job to be executed, are provided. The dividing portion divides the image formation job so that the segments of the image formation job distributed to the respective printers end almost simultaneously.

### BACKGROUND OF THE INVENTION

1. Field of the Invention

The present invention relates to an information processing apparatus that requests an image forming apparatus to form an image, and to the image forming apparatus.

2. Description of the Related Art

In order to shorten a time needed to complete printing, it is known in the prior art to divide a print job by a PC (Personal Computer), so that respective divided segments of the print job are executed on different printers. For example, Japanese Unexamined Patent Publication No. 11-296333 discloses a print job distribution method by which the client computer divides a print job, and respective print job segments are transmitted to a plurality of network printers. Also, Japanese Unexamined Patent Publication No. 2004-178362 discloses a document management system that divides an image formation job when the user selects distributed printing, and distributes the divided job segments to a plurality of printers for printing to be executed. In this system, the number of print copies to be made by each printer is inputted manually by the user.

In the prior art as described above, however, because the printing end periods for the pieces of data distributed to the respective printers are not concerned, there is a need to improve the technique for further shortening the printing time.

### SUMMARY OF THE INVENTION

It is an object of the present invention to provide an information processing technology and an image forming technology which are free from the problems residing in the prior art.

It is another object of the, present invention to provide a technology which can shorten the printing time when print data is divided and distributed to a plurality of printers for printing to be executed.

According to an aspect of the present invention, an information processing apparatus is connectable with a plurality of image forming apparatus via a telecommunication line. The information processing apparatus comprises: a group storage portion that stores a group made up of a plurality of image forming apparatus; a printing rate storage portion that stores printing rates of the plurality of image forming apparatus in correlation with respective image forming apparatus; a job acceptance portion that accepts a user's input of an image formation job to form an image on a recording sheet; a dividing portion that divides the image formation job accepted at the job acceptance portion in units of pages for the respective image forming apparatus in the group stored in the group storage portion; and a control portion that distributes respective segments of the image formation job divided by the dividing portion to the respective image forming apparatus for the image formation job to be executed. The dividing portion divides the image formation job on a basis of the printing rates stored in the printing rate storage portion so that printing times in the respective image forming apparatus become substantially equal.

With this construction, one image formation job is divided into a plurality of segments to allocate more pages to an image forming apparatus having a higher printing rate, so that the segments of the image formation job distributed to a plurality of image forming apparatus end almost simultaneously. The segments of the image formation job distributed to the respective image formation devices therefore end almost simultaneously. It is thus possible to complete the image formation in a shorter time.

### BRIEF DESCRIPTION OF THE DRAWINGS

FIG. 1 is a block diagram showing a connection relation between an information processing apparatus and an image forming apparatus according to an embodiment of the invention.

FIG. 2 is a block diagram showing a mechanical and functional configuration of the information processing apparatus.

FIG. 3 is a block diagram showing a functional configuration of the information processing apparatus and the image forming apparatus.

FIG. 4 is a view showing one example of a manipulation screen to set a group printer and to input a print command as one example of a manipulation on the information processing apparatus.

FIG. 5 is a view showing one example of a display manipulation of a printing end status as one example of a manipulation on the information processing apparatus.

FIG. 6 is a flowchart showing a flow of printing processing by the information processing apparatus and the image forming apparatus.

### DETAILED DESCRIPTION OF THE PREFERRED EMBODIMENTS

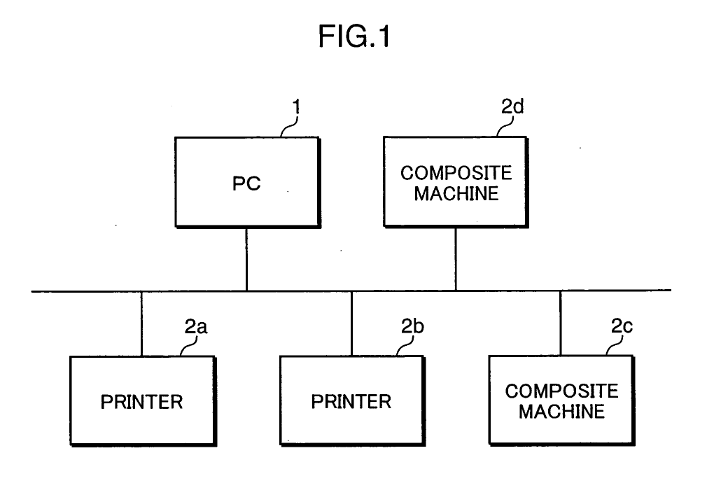

Hereinafter, one embodiment of the invention will be described with reference to the drawings. FIG. 1 is a block diagram showing configurations of a PC (Personal Computer) 1 serving as an information processing apparatus and a plurality of image forming apparatus (printer 2a, printer 2b, composite machine 2c, and composite machine 2d) 2 furnished with the printing function according to one embodiment of the invention. Each of the composite machines 2c and 2d is a copying machine furnished with the printing function. Hereinafter, the composite machine is also referred to as the printer. The PC 1 and the printers 2a, 2b, 2c, and 2d are interconnected via the network to enable communications. The number of printers 2 linked to the network can be set arbitrarily.

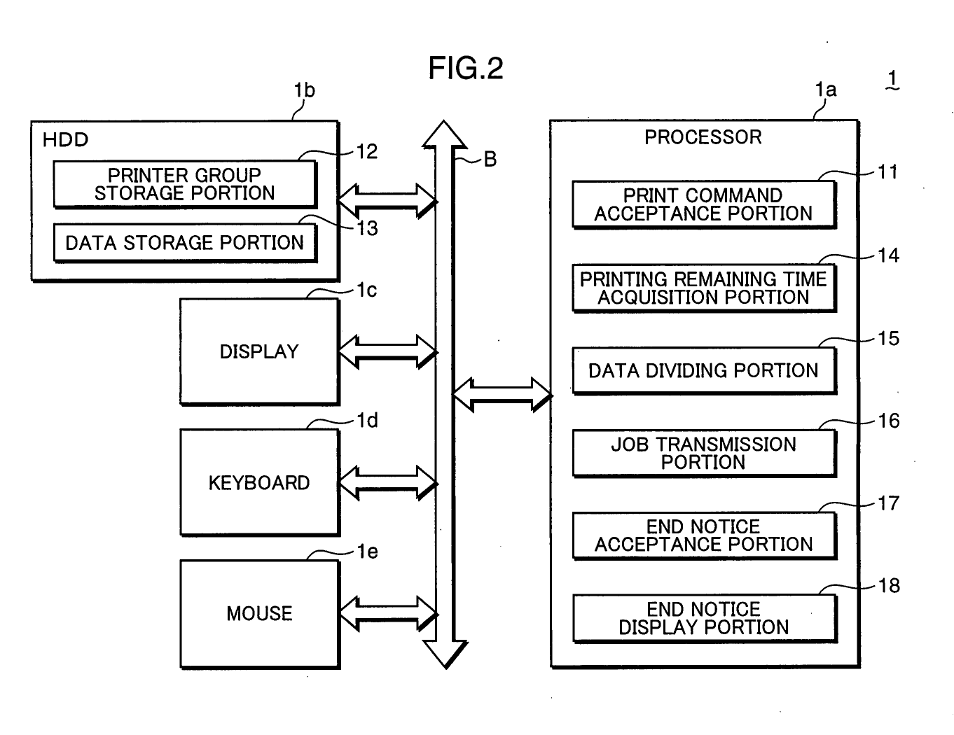

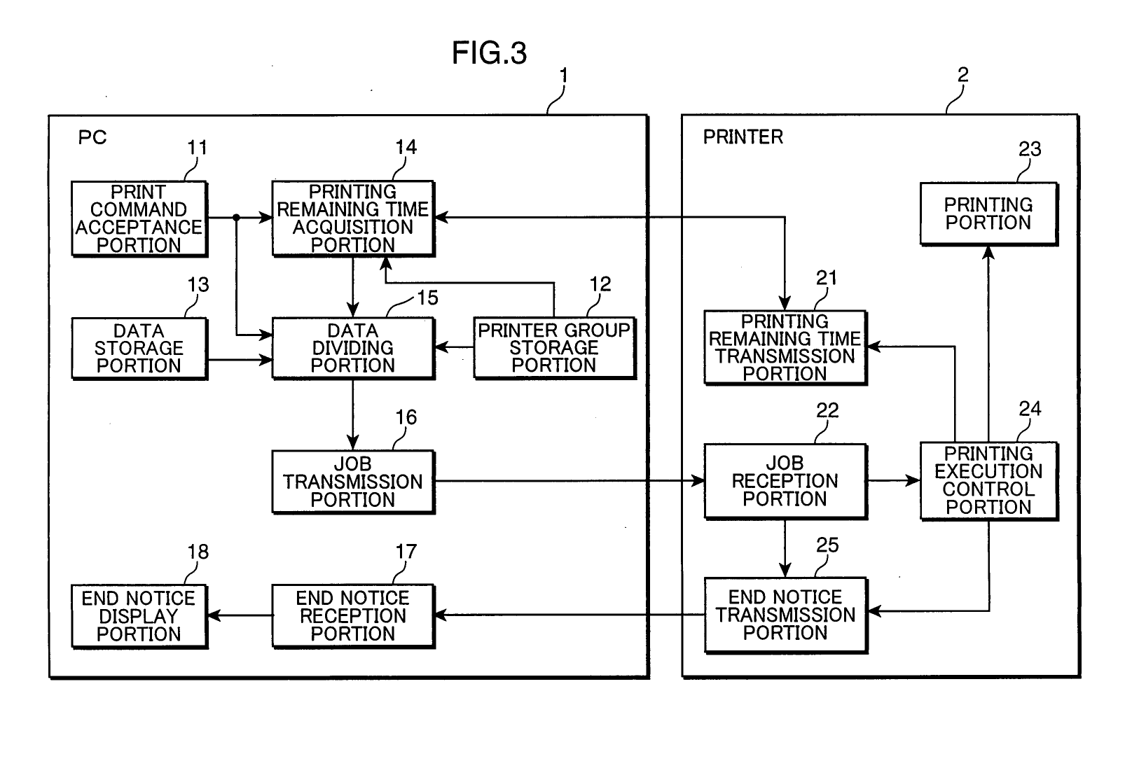

FIG. 2 is a block diagram showing the mechanical and functional configuration of the PC 1 according to the one embodiment of the invention. The PC 1 includes, as the mechanical configuration, a bus B, and a processor 1a , an HDD (hard disc drive) 1b , a display 1c , a keyboard id, and a mouse 1e that are interconnected via the bus B. The processor 1a reads out a program stored in the HDD 1b and runs the program. The processor 1a includes a CPU (Central Processing Unit) and a RAM (Random Access Memory). The processor 1a functions as all of the followings: a print command acceptance portion 11, a printing remaining time acquisition portion 14, a data dividing portion 15, a job transmission portion 16, an end notice reception portion 17, and an end notice display'portion 18. These functional portions will be described with reference to FIG. 3 below.

The HDD 1b is an auxiliary storage device provided to the PC 1, and comprises a non-volatile storage device to store a program or the like in a magnetic disc. The display 1c , the keyboard 1d, and the mouse 1e are the user interfaces provided to the PC 1. The display 1c is an output device to display an image and characters. The keyboard 1d is an input device used to input characters and the like. The mouse 1e is a pointing device used to move the cursor displayed on the display 1c and to choose an icon or the like at the cursor position.

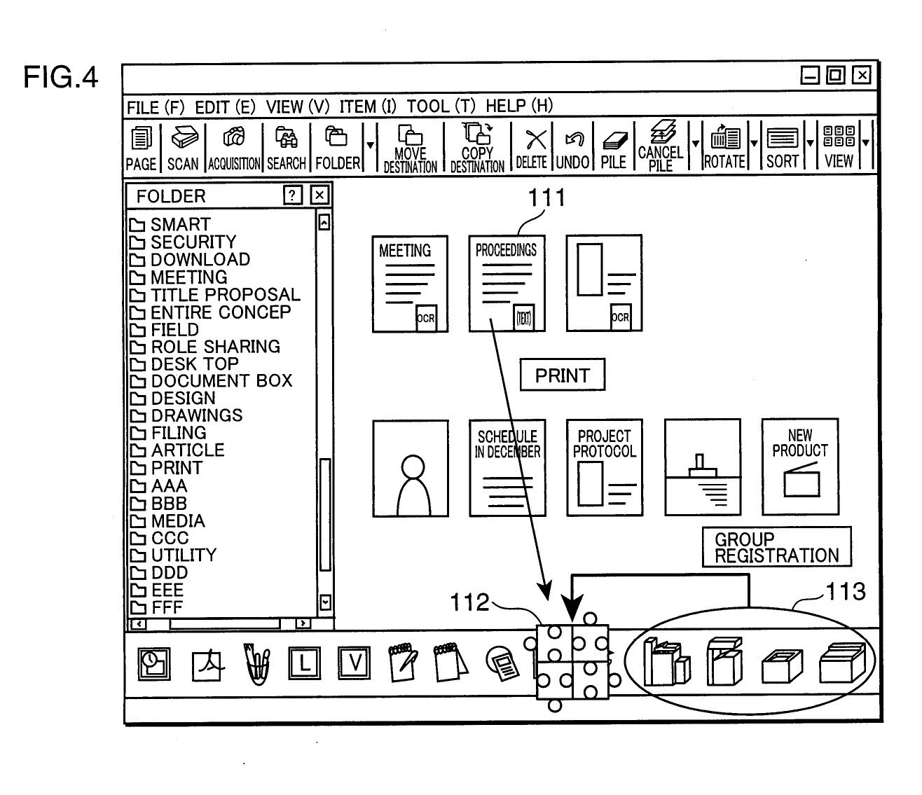

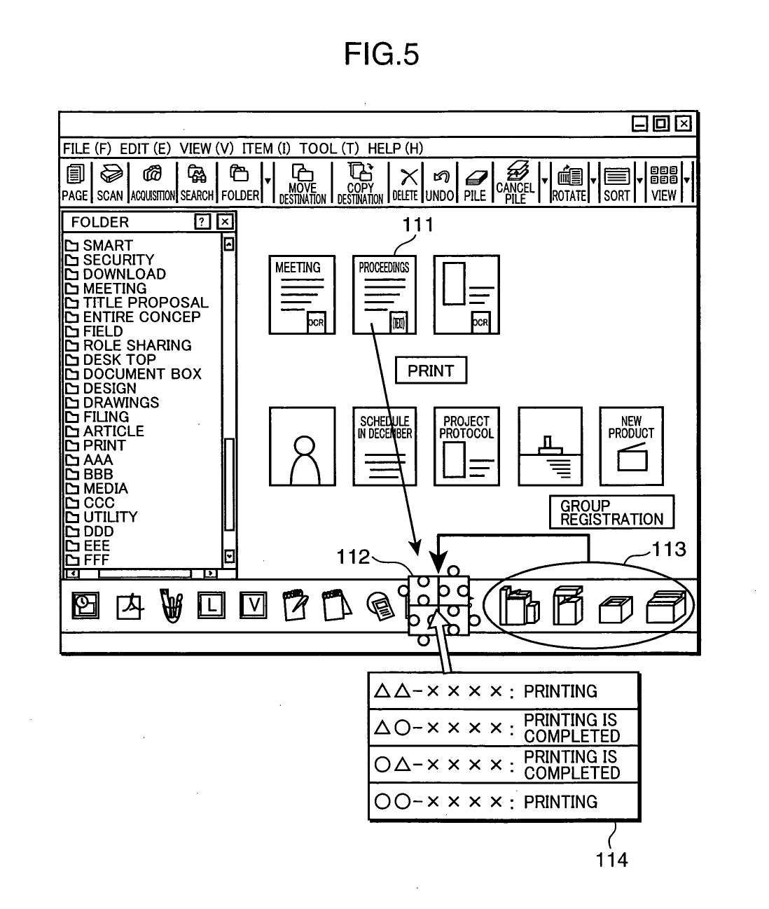

FIG. 3 is a block diagram showing the functional configurations of the PC 1 and the printer 2 according to the one embodiment of the invention. FIG. 4 and FIG. 5 are views showing one example of a manipulation on the information processing apparatus according to the one embodiment of the invention. FIG. 4 shows an example of a manipulation screen to set a printer group and to input a print command. FIG. 5 shows an example of a display manipulation for the printing end status. The PC 1 includes the print command acceptance portion 11, a printer group storage portion 12, a data storage portion 13, the printing remaining time acquisition time 14, the data dividing portion 15, the job transmission portion 16, the end notice reception portion 17, and the end notice display portion 18.

The print command acceptance portion 11 accepts a print command inputted by the user. Together with the print command, the print command acceptance portion 11 accepts a specification of data (file) to be printed and a command to specify the plurality of printers 2 to execute printing for divided pieces of data. More specifically, the print command acceptance portion 11 accepts a print command by accepting a manipulation that the user drags and drops, for example, an icon 111 of print data displayed on the display 1c onto an icon (printer group icon) 112 in which the plurality of printers 2 are registered (see FIG. 4). In a case where the plurality of printers 2 to execute printing have been specified previously as a default printer group, only the print data is accepted. In a case where printing is executed by specifying the print data alone, the print command acceptance portion 11 accepts the print command by accepting, for example, a manipulation that the user chooses the print menu from the menu bar that is displayed when the file of the data is opened, or a manipulation that the user chooses the print menu by moving the cursor onto the icon of the data.

In order to set the printer group icon (that is, to set printers 2 to be included in the printer group represented by this icon), the user chooses icons 113 of the plurality of printers 2, and drags and drops these icons 113 onto the printer group icon 112 (see FIG. 4).

The printer group storage portion 12 stores a set (printer group) of the plurality of printers 2 connected to the PC 1 via the network in-correlation with the printing rates and the network addresses for the respective printers 2. The printer group storage portion 12 stores, for example, the number of sheets printed for one minute as the printing rate. The printer group storage portion 12 is, for example, the HDD 1b.

The data storage portion 13 stores data (application data) to be printed. This is the data created by the user using application software, for example, word processor software or drawing creation software, and stored in the form of a file. The data storage portion 13 is, for example, the HDD 1b.

The printing remaining time acquisition portion 14 acquires information as to whether the respective printers 2 in the specified printer group are currently executing printing, and a time required for the printing to end if printing is in execution (hereinafter, referred to as the printing remaining time). The printing remaining time acquisition time 14 reads out the network address of each printer 2 (that is, each printer 2 that executes printing for a distributed piece of data) in the specified printer group from the printer group storage portion 12. The printing remaining time acquisition portion 14 then makes an inquiry to a printing remaining time transmission portion 21 in each printer 2 at the network address acquired from the printer group storage portion 12 about whether the printer 2 is currently executing printing as well as the printing remaining time (hereinafter, referred to collectively as the printing remaining time), and receives a reply from the printing remaining time transmission time 21 in the printer 2. The printing remaining time acquisition portion 14 then delivers the printing remaining time of each printer 2 thus received to the data dividing portion 15.

The data dividing portion 15 divides the data specified for printing by the print command acceptance portion 11 to distribute the data to the plurality of printers 2. The data dividing portion 15 first reads out the data specified for printing by the print command acceptance portion 11 from the data storage portion 13. The data dividing portion 15 then reads out the network addresses and the printing rates of all the printers 2 in the specified printer group from the printer group storage portion 12. Subsequently, the data dividing portion 15 divides the data in units of pages on the basis of the printing remaining time of each printer 2 delivered from the printing remaining time acquisition potion 14 and the printing rate of each printer 2 read from the printer group storage portion 12, so that when the data is distributed to the respective printers 2, all the printers 2 end the printing almost simultaneously, that is, in almost the shortest time.

The dividing method will now be described more specifically. For example, when data is divided to four printers 2a, 2b, 2c, and 2d, as a first case, assume that for the printers 2a, 2b, 2c, and 2d, all the printing remaining times are 0 minute, and the printing rates are 60 sheets/min, 35 sheets/min, 20 sheets/min, and 15 sheets/min, respectively. Then, in order to print 1000 sheets, 1000 sheets are divided first in proportion to the printing rates of the respective printers 2a, 2b, 2c, and 2d. Initially, 1000 sheets are divided by 130 sheets, which is the sum of sheets printed for one minute by all the printers 2. A time needed for printing is thus found to be 7.6 minutes (round off to the first decimal place). The number of sheets printed by each printer 2 is then found by multiplying the time found as above by the number of sheets printed for one minute. That is, 60 sheets×7.6=456 sheets for the printer 2a, 35 sheets ×7.6=266 sheets for the printer 2b, 20 sheets×7.6=152 sheets for the printer 2c, and 15 sheets×7.6=114 sheets for the printer 2d (round off to the whole number when necessary). The remaining 12 sheets as the result of the rounding off are printed by the printer 2a having the highest printing rate.

Consequently, the job of printing 1000 sheets is divided as follows: 468 sheets are allocated to the printer 2a, 266 sheets to the printer 2b, 152 sheets to the printer 2c, and 114 sheets to the printer 2d. The logical printing end periods using this dividing result are 7 minutes and 48 seconds later for the printer 2a, 7 minutes and 36 seconds later for the printer 2b, 7 minutes and 36 seconds later for the printer 2c, and 7 minutes and 36 seconds later for the printer 2d. The printing end periods therefore come almost simultaneously.

As a second case, assume that for the printers 2a, 2b, 2c, and 2d, the printing remaining times are 0 minute, 5 minutes, 2 minutes, and 0 minute, and the printing rates are 60 sheets/minute, 35 sheets/minute, 20 sheets/minute, and 15 sheets/minute, respectively. Then, in order to print 1000 sheets, the numbers of sheets that can be printed by the printer 2a and the printer 2d by the time the printer 2c ends the printing that is currently executed (2 minutes), which are found to be 120 sheets and 30 sheets, respectively. Further, the numbers of sheets that can be printed by the printer 2a, the printer 2c, and the printer 2d since the printer 2c ends the printing that is currently executed until the printer 2b ends the printing that is currently executed (3 minutes), which are found to be 180 sheets, 60 sheets, and 45 sheets, respectively.

Because the sum of sheets that can be printed by the printers 2a, 2c, and 2d by the time the printer 2b ends the printing that is currently executed is 435 sheets, the remaining 565 sheets are divided in proportion to the printing rates of the respective printers 2a, 2b, 2c, and 2d. Accordingly, the remaining 565 sheets are divided by 130 sheets, which is the sum of sheets printed for one minute by all the printers 2. A time needed for printing is thus found to be 4.3 minutes (round off to the first decimal place). The number of sheets printed by each printer 2 is then found by multiplying the time found as above by the number of sheets printed for one minute. That is, 60 sheets×4.3=258 sheets for the printer 2a, 35 sheets×4.3=150 sheets for the printer 2b, 20 sheets×4.3=86 sheets for the printer 2c, and 15 sheets×4.3=64 sheets for the printer 2d (round off to the whole number when necessary). The remaining 7 sheets as the result of the rounding off are printed by the printer 2a having the highest printing rate.

Consequently, the job of printing 1000 sheets is divided as follows: 565 sheets are allocated to the printer 2a, 150 sheets to the printer 2b, 146 sheets to the printer 2c, and 139 sheets to the printer 2d. The logical printing end periods using this dividing result are 9 minutes and 25 seconds later for the printer 2a, 9 minutes and 17 seconds later for the printer 2b, 9 minutes and 18 seconds later for the printer 2c, and 9 minutes and 16 seconds later for the printer 2d. The printing end periods therefore come almost simultaneously.

The data dividing portion 15 transmits the pieces of data thus divided to the job transmission portion 16 in correlation with the network addresses of the printers 2 that will execute printing for these divided pieces of data.

The job transmission portion 16 requests the respective printers 2 to execute printing for the respective pieces of data by transmitting the respective pieces of data received from the data dividing portion 15 to the printers 2 at the correlated network addresses.

The end notice reception portion 17 receives an end notice from each printer 2 when each printer 2 ends the printing of the job requested from the PC 1. When the end notice is received from the printer 2, the end notice reception portion 17 transmits the end notice and the network address of the printer 2 that has sent the end notice to the end notice display portion 18.

The end notice display portion 18 displays whether printing requested by the PC 1 has ended on the display 1c. When the end notice and the corresponding network address are received from the end notice reception portion 17, the display notice display portion 18 updates the display (printing status display) information informing that the printing requested by the PC 1 ends in the printer 2 at the received network address. An example of the printing status display is shown in FIG. 5. It is displayed, for example, when the user clicks the right button of the mouse 1e while the cursor is fixed onto the group printer icon 112 on the window displayed on the display 1c.

The printer 2 includes the printing remaining time transmission portion 21, a job reception portion 22, a printing portion 23, a printing execution control portion 24, and an end notice transmission portion 25.

The printing remaining time transmission portion 21 transmits the printing remaining time to the PC 1. When an inquiry about the printing remaining time is received from the printing remaining time acquisition portion 14 in the PC 1, the printing remaining time transmission portion 21 acquires the printing remaining time from the printing execution control portion 24, and transmits the printing remaining time thus acquired to the printing remaining time acquisition portion 14.

The job reception portion 22 receives a print job from the information processing apparatus that is the request sender of the print job, for example, the PC 1. When the print job is received from the job transmission portion 16 in the PC 1, the job reception portion 22 delivers the received print job to the printing execution control portion 24, and the same time, it delivers the identification information of the request-sender PC 1, for example, the network address, to the end notice transmission portion 25.

The printing portion 23 forms an image on a recording sheet. The printing portion 23-receives the specification of a recording sheet, the image data, and the number of print copies from the printing execution control portion 24, and forms the image of the image data on as many recording sheets as the specified number of print copies.

The printing execution control-portion 24 controls the printing portion 23 to form an image. When a print job is delivered from the job reception portion 22, the printing execution control portion 24 extracts the print condition (the number of print copies, the size of recording sheet, scaling up/down, etc.) and the image data from the print job, and processes an image of the image data according to the print condition. The printing execution control portion 24 then transmits the specification of a recording sheet, the image data, and the number of print copies to the printing portion 23. The printing execution control portion 24 also monitors the execution of image formation by the printing portion 23, and acquires the end of the print job executed by the printing portion 23. Upon acquisition of the end of the print job, the printing execution control portion 24 notifies the end notice transmission portion 25 of the acquisition. In response to an inquiry from the printing remaining time transmission portion 21, the printing execution control portion 24 returns “0” as the printing remaining time when no printing is currently executed; when the print job is currently executed, it returns the printing remaining time of the job that is currently executed.

When the notice informing the end of the print job is received from the printing execution control portion 24, the end notice transmission portion 25 transmits the end notice to the request-sender information processing apparatus on the basis of the identification information of the request-sender information processor delivered from the job reception portion 22.

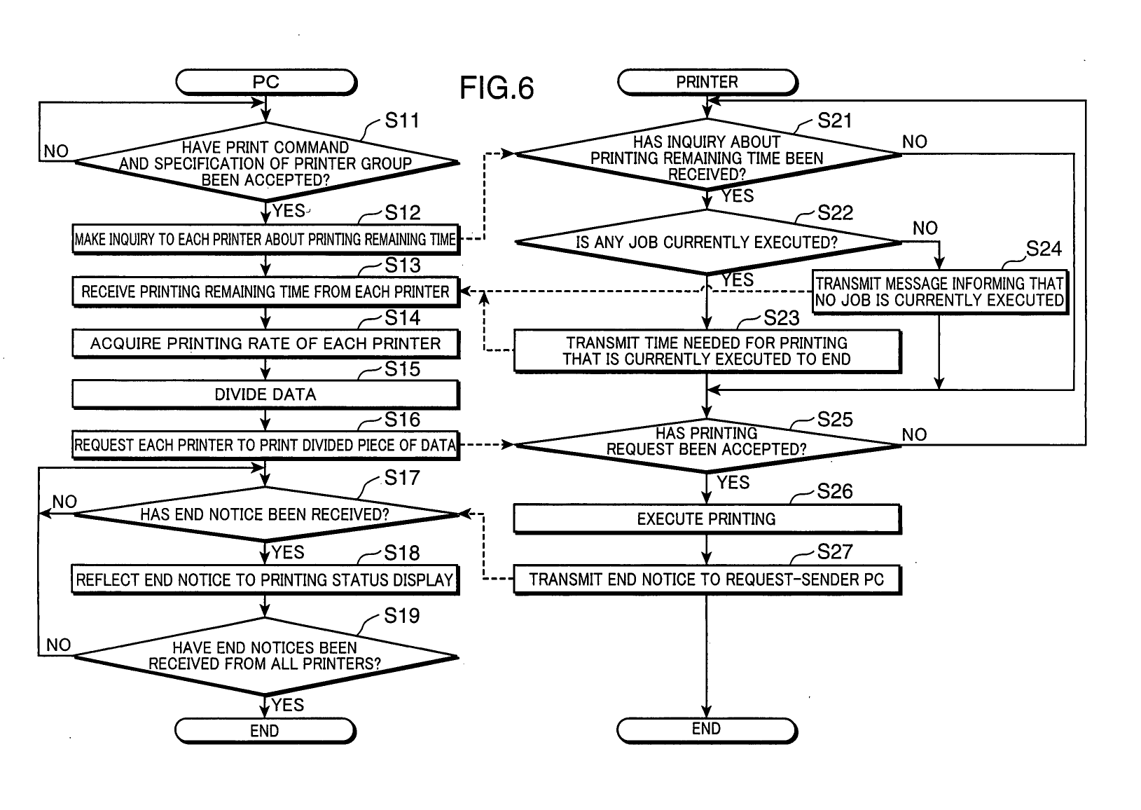

The flow of the printing processing by the PC 1 and the printer 2 will now be described. FIG. 6 is a flowchart showing the printing processing by the PC 1 and the printer 2.

On the PC 1 side, in Step S11, the print command acceptance portion 11 checks whether the specification of the printer group, specification of the data to be printed, and an input of the print command made by the user have been accepted. In the case of non-acceptance (NO in Step S11), the flow returns to Step S11. When the specification of the printer group and the print command have been accepted (YES in Step S11), the print command acceptance portion 11 transmits the type information of the specified printer group to the printing remaining time acquisition portion 14. The flow then proceeds to Step S12.

In Step S12, the printing remaining acquisition portion 14 reads out the network addresses of the respective printers 2 in this printer group from the printer group storage portion 12 on the basis of the received type information of the printer group. The data dividing portion 15 then transmits inquires to the respective printers 2 at the read network addresses about the printing remaining times. In Step S13, the printing remaining time acquisition portion 14 receives the printing remaining times as replies from the respective printers 2 to which the inquiries about the printing remaining time are transmitted. The printing remaining time acquisition portion 14 then transmits the printing remaining times thus received to the data dividing portion 15 in correlation with the network addresses.

In Step S14, the data dividing portion 15 reads out the printing rates of the respective printers 2 in the specified printer group from the printer group storage portion 12. In Step S15, the data dividing portion 15 divides the print data stored in the data storage portion 14 in units of pages on the basis of the printing remaining times acquired in Step S13 and the printing rates acquired in Step S14 so that all the printers 2 in the specified printer group end printing almost simultaneously. The data dividing portion 15 then transmits the divided pieces of data to the job transmission portion 16 together with the network addresses of the printers 2 that will execute printing for the divided pieces of data. In Step S16, the job transmission portion 16 transmits segments of the print job for these divided pieces of data thus received to the printers 2 at the corresponding network addresses.

In Step S17, the end notice reception portion 17 checks whether the end-notice has been received from each printer 2. In the case of non-reception (NO in Step S17), Step S17 is repeated. Upon reception of the end notice (YES in Step'S17), the end notice reception portion 17 delivers the end notice to the end notice display portion 18. The flow then proceeds to Step S18. In Step S18, the end notice display portion 18 updates the printing status display of the printer 2 from which the end notice has been received to a state indicating the end of printing. In Step S19, the end notice reception portion 17 checks whether the end notices have been received from all the printers 2 in the specified printer group. When there is a printer 2 from which the end notice has not been received (NO in Step S19), the flow returns to Step S17. When the end notices have been received from all the printers 2 (YES in Step S19), the processing involved with printing is terminated.

On the printer 2 side, in Step S21, the printing remaining time transmission portion 21 checks whether an inquiry about the printing remaining time has been received. The flow proceeds to Step S22 when the inquiry has been received (YES in Step S21). In Step S22, the printing remaining time transmission portion 21 makes an inquiry to the printing execution control portion 24 about whether any printing is currently executed. When printing is currently executed, the flow proceeds to Step S23. In Step S23, the printing remaining time transmission portion 21 acquires the remaining time (printing remaining time) from now until the printing that is currently executed ends from the printing execution control portion 24, and transmits the acquired printing remaining time to the inquiry-sender PC 1.

Meanwhile, the flow proceeds to Step S24 when no printing is currently executed in Step S22 (NO in Step S22). In Step S24, the printing remaining time transmission portion 21 transmits, for example, the printing remaining time set to “0” to inform that no printing is currently executed to the inquiry-sender PC 1. The flow proceeds to Step S25 when the inquiry about the printing remaining time has not been received in Step S21 (NO in Step S21), when the processing in Step S23 ends, or when the processing in Step S24 ends.

In Step S25, the job reception portion 22 checks whether a print job has been accepted. In the case of non-acceptance (NO in Step S25), the flow returns to Step S21. Upon acceptance of the print job (YES in Step S25), the job reception portion 22 delivers the accepted print job to the printing execution control portion 24, and at the same time, it delivers the network address of the PC 1, which is the request sender of the print job, to the end notice transmission portion 25. The flow then proceeds to Step S26. In Step S26, the printing execution control portion 24 makes the printing portion 23 execute the delivered print job. When the printing execution control portion 24 detects the end of the printing, it notifies the end notice transmission portion 25 of the end of the printing. In Step S27, upon receipt of the information, the end notice transmission portion 25 transmits the end notice to the job-request-sender PC 1.

As has been described, in this embodiment, a print job specified on the PC 1 is distributed to a plurality of printers 2 for printing to be executed. In this instance, because the data dividing portion 15 divides the print data in such a manner the respective printers 2 end the printing thus distributed almost simultaneously, it is possible to end the printing in a shorter time.

The invention is not limited to the embodiment above, and can be modified as described below. The calculation method for dividing data in the embodiment above is described by way of example, and the invention is not limited to this example.

The setting of the printer group, a print command, and the manipulation method of the printing status display described in the embodiment above are also described by way of example, and the invention is not limited to these examples. In addition, in the embodiment above, the printing statuses of the respective printers in the group printer are displayed individually as the print display. However, it may be configured to display only whether the printing by all the printers is completed.

In summary, an information processing apparatus connectable with a plurality of image forming apparatus via a telecommunication line, comprises: a group storage portion that stores a group made up of plural image forming apparatus; a printing rate storage portion that stores printing rates of the plural image forming apparatus in correlation with respective image forming apparatus; a job acceptance portion that accepts a user's input of an image formation job to form an image on a recording sheet; a dividing portion that divides the image formation job accepted at the job acceptance portion in units of pages for the respective image forming apparatus in the group stored in the group storage portion; and a control portion that distributes respective segments of the image formation job divided by the dividing portion to the respective image forming apparatus for the image formation job to be executed, wherein the dividing portion divides the image formation job on a basis of the printing rates stored in the printing rate storage portion so that printing times in the respective image forming apparatus become substantially equal.

Also, a recording medium recorded with operation control program causes an information processing apparatus connectable with a plurality of image forming apparatus via a telecommunication line to function as portions as follows: a job acceptance portion that accepts a user's input of an image formation job to form an image on a recording sheet; a dividing portion that divides the image formation job accepted at the job acceptance portion in units of pages for respective image forming apparatus in a group stored in a group storage portion that stores a group made up of plural image forming apparatus; and a control portion that distributes respective segments of the image formation job divided by the dividing portion to the respective image forming apparatus for the image formation job to be executed, wherein the dividing portion divides the image formation job on a basis of printing rates stored in a printing rate storage portion that stores printing rates of the plural image forming apparatus, so that printing times in the respective image forming apparatus become substantially equal.

Further, an image forming system is provided with a plurality of image forming apparatus and an information processing apparatus connected via a telecommunication line. The information processing apparatus includes: a group storage portion that stores a group made up of a plurality of image forming apparatus; a printing rate storage portion that stores printing rates of the plural image forming apparatus in correlation with respective image forming apparatus; a job acceptance portion that accepts a user's input of an image formation job to form an image on a recording sheet; a dividing portion that divides the image formation job accepted at the job acceptance portion in units of pages for the respective image forming apparatus in the group stored in the group storage portion; and a control portion that distributes respective segments of the image formation job divided by the dividing portion to the respective image forming apparatus for the image formation job to be executed, wherein the dividing portion divides the image formation job on a basis of the printing rates stored in the printing rate storage portion so that printing times in the respective image forming apparatus become substantially equal. Each image forming apparatus includes: a divided job acceptance portion that accepts one segment of the image formation job distributed to the image forming apparatus by the control portion of the information processing apparatus; an execution portion that executes the segment of the image formation job accepted at the divided job acceptance portion; a detection portion that detects an end of execution of the segment of the image formation job by the execution portion; and an end notice transmission portion that transmits an end notice to the information processing apparatus, which is a request sender of the image formation job, when the end of execution of the segment of the image formation job is detected by the detection portion.

When configured in this manner, one image formation job is divided into plural segments to allocate more pages to an image forming apparatus having a higher printing rate, so that the segments of the image formation job distributed to plural image forming apparatus end almost simultaneously. The segments of the image formation job distributed to the respective image formation devices therefore end almost simultaneously. It is thus possible to complete the image formation in a shorter time.

Furthermore, an information processing apparatus connectable with a plurality of image forming apparatus via a telecommunication line, includes: a group storage portion that stores a group made up of plural image forming apparatus; a printing rate storage portion that stores printing rates of the plural image forming apparatus in correlation with respective image forming apparatus; a job acceptance portion that accepts a user's input of an image formation job to form an image on a recording sheet; a dividing portion that divides the image formation job accepted at the job acceptance portion in units of pages for the respective image forming apparatus in the group stored in the group storage portion; an acquisition portion that acquires information about a time needed for another image formation job to end from each image forming apparatus when the image forming apparatus is currently executing another image formation job; and a control portion that distributes respective segments of the image formation job divided by the dividing portion to the respective image forming apparatus for the image formation job to be executed, wherein the dividing portion divides the image formation job in such a manner that a sum of the printing time and the time acquired by the acquisition portion becomes substantially equal for all the image forming apparatus when all the image forming apparatus execute printing for the image formation job at the printing rates stored in the printing rate storage portion.

When configured in this manner, the image formation job is divided in such a manner that a sum of the printing time and the time acquired by the acquisition portion becomes substantially equal for all the image forming apparatus when the segments of the image formation job distributed to plural image forming apparatus are executed by the respective image forming apparatus. The segments of the image formation job distributed to the respective image forming apparatus therefore end at further closer timings. It is thus possible to complete the image formation in a further shorter time.

The information processing apparatus may further include a reception portion that receives end notices from the respective image forming apparatus when the image formation job for the information processing apparatus ends, and a display portion that displays a message informing the end of the image formation job when the end notices are received at the reception portion.

When configured in this manner, because the information about the end of the image formation distributed to the respective image forming apparatus is displayed on the information processing apparatus, which is the request sender of the formation job, the user can readily know whether the image formation distributed to the respective image formation devices has ended at the installation location of the information processing apparatus, which is the request sender of the image formation job.

The information processing apparatus may be configured in such a manner that the control portion makes an image forming apparatus stored in the printing rate storage portion as having a highest printing rate among all the image forming apparatus execute a segment of the image formation job for pages left as a remainder of division by the dividing portion.

When configured in this manner, the segment of the image formation job for pages left as a remainder of the division is allocated to the image forming apparatus having the highest printing rate. It is thus possible to determine to which image forming apparatus the remainder pages should be allocated with ease while keeping the end periods of the image formation in the respective image forming apparatus to which the image formation is distributed at almost the simultaneous timing.

In addition, an image forming apparatus connectable with an information processing apparatus via a telecommunication line, includes: a divided job acceptance portion that accepts one of segments obtained by dividing one image formation job into plural segments in units of pages from the information processing apparatus; an execution portion that executes the segment of the image formation job accepted at the divided job acceptance portion; a detection portion that detects an end of execution of the segment of the image formation job by the execution portion; and an end notice transmission portion that transmits an end notice to the information processing apparatus, which is a request sender of the image formation job, when the end of execution of the segment of the image formation job is detected by the detection portion.

When configured in this manner, because the end of the image formation by the image forming apparatus is notified to the request-sender information processing apparatus, the user can readily know whether the image formation has ended at the installation location of the information processing apparatus, which is the request sender of the image formation job.

This application is based on Japanese Patent Application No. 2004-373888 filed on Dec. 24, 2004, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An information processing apparatus connectable with a plurality of image forming apparatus via a telecommunication line, comprising:
a group storage portion that stores a group made up of a plurality of image forming apparatus;
a printing rate storage portion that stores printing rates of the plurality of image forming apparatus in correlation with respective image forming apparatus;
a job acceptance portion that accepts a user's input of an image formation job to form an image on a recording sheet;
a dividing portion that divides the image formation job accepted at the job acceptance portion in units of pages for the respective image forming apparatus in the group stored in the group storage portion; and
a control portion that distributes respective segments of the image formation job divided by the dividing portion to the respective image forming apparatus for the image formation job to be executed,
wherein the dividing portion divides the image formation job on a basis of the printing rates stored in the printing rate storage portion so that printing times in the respective image forming apparatus become substantially equal.

2. An information processing apparatus connectable with a plurality of image forming apparatus via a telecommunication line, comprising:
a group storage portion that stores a group made up of a plurality of image forming apparatus;
a printing rate storage portion that stores printing rates of the plurality of image forming apparatus in correlation with respective image forming apparatus;
a job acceptance portion that accepts a user's input of an image formation job to form an image on a recording sheet;
a dividing portion that divides the image formation job accepted at the job acceptance portion in units of pages for the respective image forming apparatus in the group stored in the group storage portion;
an acquisition portion that acquires information about a time needed for another image formation job to end from each image forming apparatus when the image forming apparatus is currently executing another image formation job; and
a control portion that distributes respective segments of the image'formation job divided by the dividing portion to the respective image forming apparatus for the image formation job to be executed,
wherein the dividing portion divides the image formation job in such a manner that a sum of the printing time and the time acquired by the acquisition portion becomes substantially equal for all the image forming apparatus when all the image forming apparatus execute the image formation job at the printing rates stored in the printing rate storage portion.

3. The information processing apparatus according to claim 1, further comprising:
a reception portion that receives end notices from the respective image forming apparatus when the image formation job for the information processing apparatus ends; and
a display portion that displays a message informing the end of the image formation job when the end notices are received at the reception portion.

4. The information processing apparatus according to claim 2, further comprising:
a reception portion that receives end notices from the respective image forming apparatus when the image formation job for the information processing apparatus ends; and
a display portion that displays a message informing the end of the image formation job when the end notices are received at the reception portion.

5. The information processing apparatus according to claim 1, wherein:
the control portion makes an image forming apparatus stored in the printing rate storage portion as having a highest printing rate among all the image forming apparatus execute a segment of the image formation job for pages left as a remainder of division by the dividing portion.

6. The information processing apparatus according to claim 2, wherein:
the, control portion makes an image forming apparatus stored in the printing rate storage portion as having a highest printing rate among all the image forming apparatus execute a segment of the image formation job for pages left as a remainder of division by the dividing portion.

7. The information processing apparatus according to claim 3, wherein:
the control portion makes an image forming apparatus stored in the printing rate storage portion as having a highest printing rate among all the image forming apparatus execute a segment of the image formation job for pages left as a remainder of division by the dividing portion.

8. An image forming apparatus connectable with an information processing apparatus via a telecommunication line, comprising:
a divided job acceptance portion that accepts one of segments obtained by dividing one image formation job into a plurality of segments in units of pages from the information processing apparatus;
an execution portion that executes the segment of the image formation job accepted at the divided job acceptance portion;
a detection portion that detects an end of execution of the segment of the image formation job by the execution portion; and
an end notice transmission portion that transmits an end notice to the information processing apparatus, which is a request sender of the image formation job, when the end of execution of the segment of the image formation job is detected by the detection portion.

9. A recording medium recorded with an operation control program causing an information processing apparatus connectable with a plurality of image forming apparatus via a telecommunication line to perform:
a job acceptance function of accepting a user's input of an image formation job to form an image on a recording sheet;
a dividing function of dividing the image formation job accepted at the job acceptance portion in units of pages for respective image forming apparatus in a group stored in a group storage portion that stores a group made up of a plurality of image forming apparatus; and
a control function of distributing respective segments of the image formation job to the respective image forming apparatus for the image formation job to be executed,
wherein the dividing function divides the image formation job on a basis of printing rates stored in a printing rate storage portion that stores printing rates of the plurality of image forming apparatus, so that printing times in the respective image forming apparatus become substantially equal.

10. An image forming system comprising a plurality of image forming apparatus, and an information processing apparatus connected to the plurality of image forming apparatus via a telecommunication line,
wherein the information processing apparatus comprises:
a group storage portion that stores a group made up of a plurality of image forming apparatus;
a printing rate storage portion that stores printing rates of the plurality of image forming apparatus in correlation with respective image forming apparatus;
a job acceptance portion that accepts a user's input of an image formation job to form an image on a recording sheet;
a dividing portion that divides the image formation job accepted at the job acceptance portion in units of pages for the respective image forming apparatus in the group stored in the group storage portion; and
a control portion that distributes respective segments of the image formation job divided by the dividing portion to the respective image forming apparatus for the image formation job to be executed,
the dividing portion dividing the image formation job on a basis of the printing rates stored in the printing rate storage portion so that printing times in the respective image forming apparatus become substantially equal, and
wherein each of the plurality of image forming apparatus comprises:
a divided job acceptance portion that accepts one segment of the image formation job distributed to the image forming apparatus from the information processing apparatus;
an execution portion that executes the segment of the image formation job accepted at the divided job acceptance portion;
a detection portion that detects an end of execution of the segment of the image formation job by the execution portion; and
an end notice transmission portion that transmits an end notice to the information processing apparatus, which is a request sender of the image formation job, when the end of execution of the segment of the image formation job is detected by the detection portion.
